(19) United States
(12) Patent Application Publication
(10) Pub. No.: US 2024/0142567 A1
(43) Pub. Date: May 2, 2024

(54) PROCESSING RADAR SIGNALS

(71) Applicant: Infineon Technologies AG, Neubiberg (DE)

(72) Inventors: Andre Roger, München (DE); Markus Bichl, Feldkirchen-Westerham (DE); Ljudmil Anastasov, München (DE)

(21) Appl. No.: 18/487,169

(22) Filed: Oct. 16, 2023

(30) Foreign Application Priority Data
Oct. 28, 2022 (DE) 10 2022 128 752.1

(51) Int. Cl. G01S 7/02; G01S 7/35; G01S 13/87

(52) U.S. Cl. CPC G01S 7/023; G01S 7/356; G01S 13/872

(57) ABSTRACT

It is suggested to process radar signals at a first radar unit as follows: (i) receiving the radar signals via at least one receiving antenna; (ii) selecting a portion of the radar signals or of data that is based on the radar signals for further processing; and (iii) conveying a reduced amount of data to a second radar unit, wherein the reduced amount of data is based on the portion of the radar signals or of data that is based on the radar signals.

### REFERENCE TO RELATED APPLICATIONS

This application claims priority to German Patent Application 10 2022 128 752.1, filed on Oct. 28, 2022. The contents of the above-referenced Patent Application is hereby incorporated by reference in its entirety.

### BACKGROUND

Embodiments of the present invention relate to processing radar signals, in particular to units that enable or utilize such signal processing.

Processing radar signals in this regard in particular refers to radar signals received by a sensor or an antenna. Each sensor may have more than one antenna.

Several radar variants are used in cars for various applications. For example, radar can be used for blind spot detection (parking assistant, pedestrian protection, cross traffic), collision mitigation, lane change assist and adaptive cruise control. Numerous use case scenarios for radar appliances may be directed to different directions (e.g., back, side, front), varying angles (e.g., azimuth direction angle) and/or different distances (short, medium or long range). For example, an adaptive cruise control may utilize an azimuth direction angle amounting to ±18 degrees, the radar signal is emitted from the front of the car, which allows a detection range up to several hundred meters.

An objective is to improve existing solutions, in particular increase the efficiency of a radar system with distributed components.

This problem may be solved according to the features of the independent claims. Further embodiments result from the dependent claims.

### SUMMARY

The examples suggested herein may in particular be based on at least one of the following solutions. In particular combinations of the following features could be utilized in order to reach a desired result. The features of the method could be combined with any feature(s) of the device, apparatus, system or computer product or vice versa.

A method is suggested for processing radar signals at a first radar unit comprising: receiving the radar signals via at least one receiving antenna, selecting a portion of the radar signals or of data that is based on the radar signals for further processing, conveying a reduced amount of data to a second radar unit, wherein the reduced amount of data is based on the portion of the radar signals or of data that is based on the radar signals.

Hence, this approach allows to efficiently cope with a limited bandwidth connection between the first and second radar unit.

According to an embodiment, the first radar unit is a radar sensor electronic control unit.

According to an embodiment, the second radar unit is a central electronic control unit.

According to an embodiment, the portion of the radar signals or of data that is based on the radar signals is selected on at least one of the following: a random basis, a pseudo-random basis, a deterministic selection scheme.

According to an embodiment, an information regarding the portion of the radar signals or of data that is based on the radar signals is conveyed to the second radar unit.

This information may be an information regarding the reduction scheme or the selection code. It allows the second radar unit to become aware of the reduction and/or the systematic of the reduction.

According to an embodiment, the selection of the portion of the radar signals or of data that is based on the radar signals comprises at least one of the following: a selection of chirps; a selection of FFT results, in particular of first stage FFT results; a selection of at least one receiving channel; a selection of analog signals; a selection of digital signals.

According to an embodiment, the portion of the radar signals or of data that is based on the radar signals comprises output data of an interference detection.

It is an option that the selection or an additional selection utilizes an output of an interference detection (which may be obtained by an interference detection unit) to get rid of (at least a portion of) signals that are subject to interference. Such interfered signals can be omitted thereby reducing the overall communication load between the first and second radar unit.

Also, a device for processing radar signals is suggested, wherein the device comprises a processing unit that is arranged for receiving the radar signals via at least one receiving antenna, selecting a portion of the radar signals or of data that is based on the radar signals for further processing, conveying a reduced amount of data to a second radar unit, wherein the reduced amount of data is based on the portion of the radar signals or of data that is based on the radar signals.

It is noted that the steps of the method stated herein may be executable on this processing unit. It is further noted that said processing unit can comprise at least one, in particular several means that are arranged to execute the steps of the method described herein. The means may be logically or physically separated; in particular several logically separate means could be combined in at least one physical unit. The processing unit may comprise at least one of the following: a processor, a microcontroller, a hard-wired circuit, an ASIC, an FPGA, a logic device.

According to an embodiment, said device is a first radar unit.

Further, a computer program product is provided, which is directly loadable into a memory of a digital processing device, comprising software code portions for performing the steps of the method as described herein.

Embodiments are shown and illustrated with reference to the drawings. The drawings serve to illustrate the basic principle, so that only aspects necessary for understanding the basic principle are illustrated. The drawings are not to scale. In the drawings the same reference characters denote like features.

### BRIEF DESCRIPTION OF THE DRAWINGS

FIG. 1 shows an exemplary radar component, which may be a radar (sensor) ECU, communicating with a central ECU.

FIG. 2 shows an exemplary radar processing flow.

FIG. 3 shows an exemplary division of the radar processing flow between a (decentralized) radar sensor ECU and a central ECU.

FIG. 4 shows an exemplary diagram visualizing a reduction of data within an MMIC.

FIG. 5 shows an exemplary diagram visualizing a reduction of data occurring at a first stage FFT unit.

FIG. 6 shows an alternative solution visualizing a reduction of data occurring within an MMIC.

### DETAILED DESCRIPTION

In a radar processing environment, a radar source emits a signal and a sensor detects a returned signal. The returned signal may be acquired in a time domain by at least one antenna, in particular by several antennas. The returned signal may then be converted into the frequency domain by conducting a Fast Fourier Transform (FFT), which may result in a signal spectrum, e.g., a signal distributed across the frequency. Frequency peaks may be used to determine potential targets, e.g., along a moving direction of a vehicle.

A Discrete Fourier Transform (DFT) may be implemented in computers by numerical algorithms or dedicated hardware. Such implementation may employ FFT algorithms. Hence, the terms “FFT” and “DFT” may be used interchangeably.

The signal emitted by each of the antennas has a ramp-shape, wherein each ramp may have a linear rising slope of frequency over time. The reflected ramps are received and further processed by the radar system. An acquisition period may comprise several ramps. Each of the ramps is also referred to as chirp. Hence, the chirp has a certain bandwidth and duration. The slope of frequency may be linear, but it may also be of different shape.

In vehicles, in particular cars, electronic architectures are more often equipped with at least one high performance electronic control unit (ECU) acting as a central ECU. With decreasing costs of computing resources, e.g., processing power and/or memory, overall costs may be optimized by shifting the processing from the distributed components, e.g., sensors, towards the increasingly powerful central ECU. This also allows using more complex approaches, e.g., algorithms processing higher resolution or improved interference mitigation to achieve the goal of a better overall performance of the radar application.

A problem of this approach lies within the amount of data to be transmitted towards the central ECU.

An exemplary solution described herein is directed to a reduction of the overall data (also referred to as “compression of data”) which efficiently copes with the bottleneck of the connection between decentralized ECUs and the central ECU.

For example, the transmission (data rate) may be adjusted to achieve a suitable compression that allows for a compromise between the following conflicting goals: the processing power (and the memory) of the de-centralized component, e.g., radar sensor, to provide radar data; and a benefit provided by the output of the central ECU based on the data obtained for the de-centralized component(s).

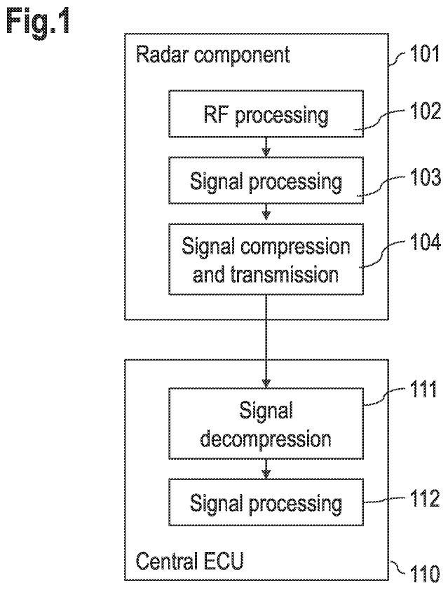

FIG. 1 shows an exemplary radar component 101, which may be a radar (sensor) ECU, comprising a radiofrequency (RF) processing 102, a signal processing 103 and a signal compression and transmission 104.

The output of the radar component 101 is connected to a central ECU 110, which comprises a signal decompression unit 111 and a signal processing unit 112.

In an exemplary scenario, several radar components 101 covey data to at least one central ECU 110. The processing power of the central ECU 110 may in particular be significantly higher than the processing power (and memory) available at each of the decentralized radar components 101. Hence, applications running at the central ECU 110 can utilize the higher computing performance to produce improved results (e.g., higher resolution, faster recognition of objects, etc.).

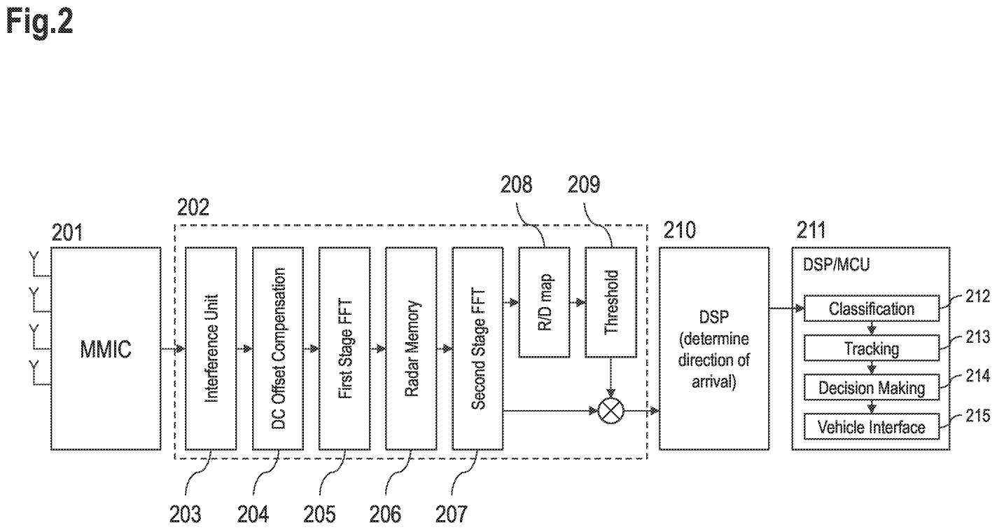

FIG. 2 shows an exemplary radar processing flow. A Monolithic Microwave Integrated Circuit (MMIC) 201 receives radar data, e.g., via several antennas. The MMIC 201 outputs analog-digital-converted (ADC) data towards a sensor preprocessing unit (SPU) 202.

The SPU 202 provides a sensor pre-processing stage and it may in particular process the received ADC data as follows: interference may be mitigated in a unit 203; a direct current (DC) offset is compensated in a DC-offset compensation unit 204; a first stage FFT is conducted in a unit 205 and the results are stored in a radar memory 206; a second stage FFT is conducted in a unit 207; the results a stored in a range/Doppler (R/D) map 208; threshold detection is conducted based on the R/D map 208 and the output of the unit 207 by a unit 209; the output of the unit 209 is multiplied with the output from the second stage FFT unit 207 and the result of this multiplication is fed to a digital signal processor (DSP) 210.

The DSP 210 may determine, e.g., a direction of arrival (based on e.g., a parabolic interpolation), and supplies its outputs towards another DSP 211.

The DSP 211 may be or comprise (at least one) microcontroller unit (MCU) and it may conduct a classification 212, a tracking 213, a decision making 214, and supply data to a vehicle interface 215.

The DSP 210 and the DSP 211 may be arranged as a single device or as multiple devices.

In FIG. 2, the output of the MMIC 201 is 100% (without compression), the output of the first stage FFT unit 205 is 100% (without compression), whereas the output of the DSP 210 may only be 2% to 5% due to the processing provided by the DSP 210.

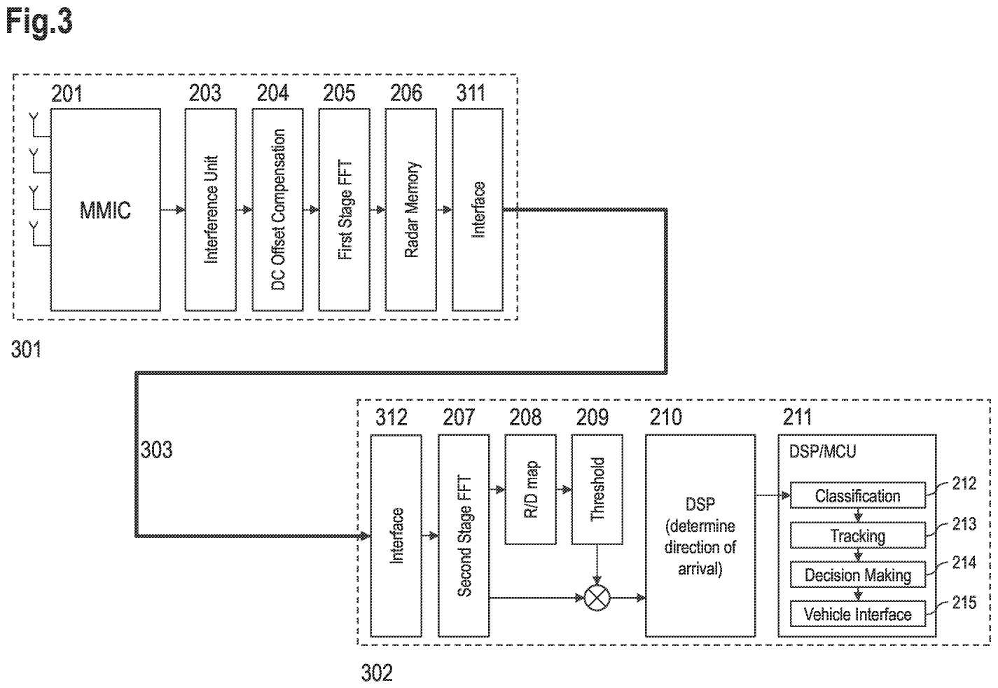

FIG. 3 shows an exemplary division of the radar processing flow between a (decentralized) radar sensor ECU 301 and a central ECU 302, which are connected, e.g., via a line 303 (which may be implemented as parallel or serial bus). In a vehicle, several radar sensor ECUs 301 may be connected to one central ECU 302.

The radar sensor ECU 301 comprises the components MMIC 201, interference unit 203, DC-offset compensation unit 204, first stage FFT unit 205 and radar memory 206 as described with regard to FIG. 2 above.

In addition, the radar sensor ECU 301 comprises an interface 311 that is connected to the line 303.

The central ECU 302 also comprises an interface 312 that is connected to the line 303. As an option, the interface 312 may be connected to several lines from other ECUs (not shown in FIG. 3).

The interface 312 feeds data to the second stage FFT unit 207. The further processing within the central ECU 302 comprising the R/D map 208, the unit 209, the DSP 210 and the DSP/MCU 211 corresponding to the components shown in and described with regard to FIG. 2.

Hence, in contrast to the radar processing flow of FIG. 2, FIG. 3 divides the processing into a portion conducted by the radar sensor ECU 301 and another portion conducted by the central ECU 302, which are both connected via interfaces 311, 312 by said line 303.

A bottleneck might be the data amounts processed by the ECU 301 to be conveyed to the central ECU 302.

An exemplary solution to overcome this obstacle suggests reducing the amount of data that has to be conveyed from the decentralized ECU 301 to the central ECU 302 across the line 303.

Such reduction (or compression) may in particular comprise at least one of the following: a selective omission of at least one signal or at least a portion of such signal; a reduction of the memory allocated by at least one signal.

The selective omission of at least one signal is also referred to as a selection of signal. Such omission may follow a random, pseudo-random or deterministic approach. It is noted that random selection may refer to a true random selection or to any selection that may have at least some degree of randomness, e.g., generated by a random generator of a deterministic machine like a microcontroller or processor.

For example, 7 out of 12 signals may be selected for further processing purposes. In other words, 5 signals are to be omitted. This selection can be made randomly, pseudo-randomly or due to a deterministic rule (e.g., following a predefined pattern stored, e.g., in a table). As a result, only 7 signals (instead of 12 signals) are conveyed towards the central ECU 302 resulting in a reduction of data to be conveyed across the line 303. This reduction of data may also be referred to as compression.

The reduction of data can be achieved at various stages within the radar sensor ECU 301. For example, the reduction may be conducted in the MMIC 201 and/or the first stage FFT unit 205.

As an option, the reduction may use a reduction scheme that is known to the central ECU 302 in order for the ECU 302 to be aware which data arrives and which data has been omitted. The reduction scheme may be known to the ECUs in advance or (at least in part) a posteriori. For example, the radar sensor ECU 301 and the central ECU 302 may dynamically agree on (e.g., by communicating over the line 303 or via a different communication means) on the reduction scheme or a modification thereof.

The solution may allow for an, e.g., up to 75%-reduction of data traffic from the radar sensor ECU 301 to the central ECU 302.

### Example 1: Reduction by Selecting Chirp Data

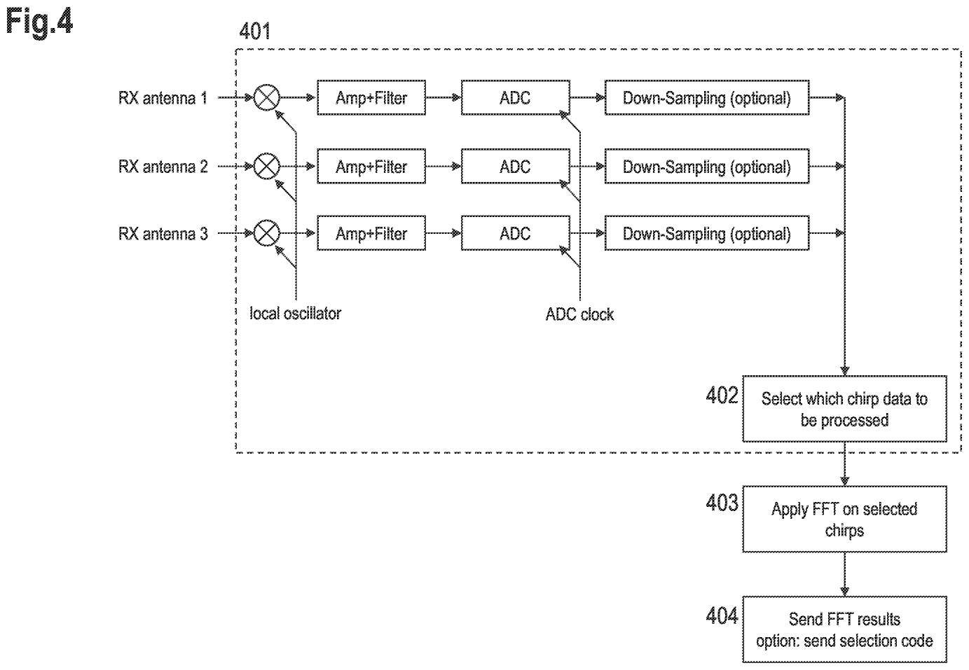

FIG. 4 shows an exemplary diagram visualizing a reduction of data within an MMIC 401. The MMIC 401 may be a schematic simplification of the MMIC 201 shown in FIG. 2 and FIG. 3.

According to the example shown in FIG. 4, the MMIC 401 comprises three receiving branches, each for one receiving antenna (RX antenna 1 to RX antenna 3). Each branch works as follows: A mixer multiplies a signal from the receiving antenna with a local oscillator signal and the result is fed to an amplifier and filter (“Amp+Filter”). The amplified and filtered result is analog-to-digital converted (using an analog-to-digital converter, ADC, with an ADC clock) and optionally down-sampled. The resulting digital signal from all branches is then further processed. Thus, each mixer has a receive input, a local oscillator input, and an output. The receive input of each mixer is coupled to a respective receiving antenna port. The local oscillator inputs are coupled to a local oscillator terminal. Each amplifier and filter unit has an input and an output. The input of each amplifier and filter unit is coupled to the output a corresponding mixer.

In the example shown in FIG. 4, the resulting digital signal is compressed by selecting which chirp is to be processed (see step 402). A random, pseudo-random or deterministic sequence can be used to select the chirps. Thus, after the optional down-conversion, a selection block, such as a multiplexor in hardware or software, can select which chip data is to be processed.

The selected chirps are then subject to a first stage FFT in a step 403 and the first stage FFT results are conveyed from the decentralized ECU 301 to the central ECU 302 in a step 404. As an option, a selection code can be conveyed together with the FFT results to let the central ECU 302 know which chirps have been omitted and/or which chirps have been processed.

### Example 2: Reduction by Selecting FFT Results

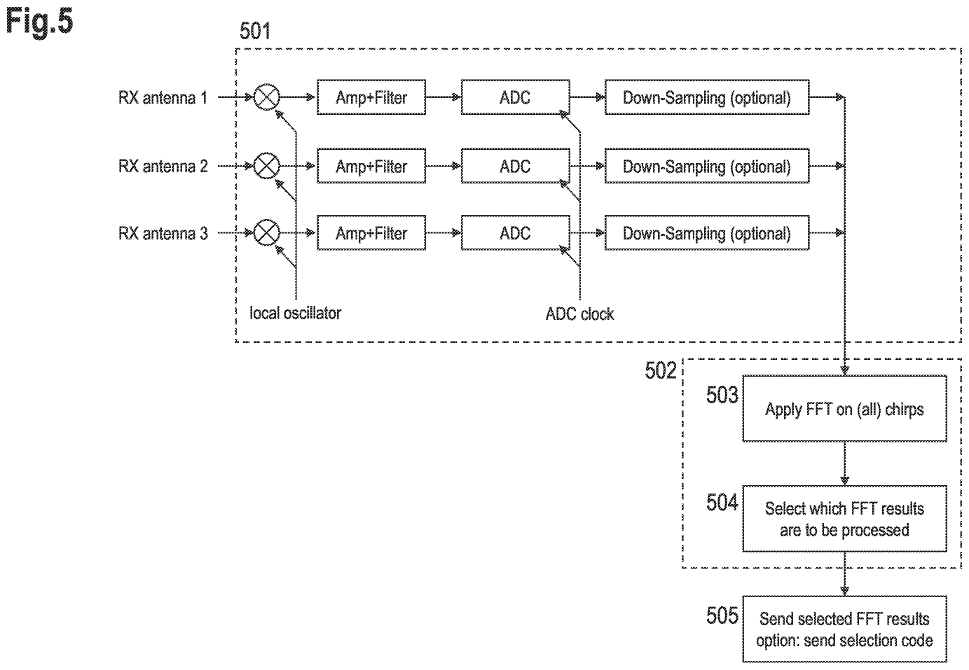

FIG. 5 shows an exemplary diagram visualizing a reduction of data occurring at a first stage FFT unit 502. An MMIC 501 may be a schematic simplification of the MMIC 201 shown in FIG. 2 and FIG. 3. The receiving branches of the MMIC 501 correspond to the receiving branches of the MMIC 401 explained above.

The resulting digital signal provided by the MMIC 501 is processed at the first stage FFT unit 502 as follows: In a step 503, the first stage FFT is applied on (all) chirps. In a subsequent step 504, a reduction is achieved by selecting only a portion of the FFT results to be processed. A random, pseudo-random or deterministic sequence can be used to select the FFT results.

These selected FFT results are conveyed from the decentralized ECU 301 to the central ECU 302 in a step 505. As an option, a selection code can be conveyed together with the FFT results to let the central ECU 302 know which chirps have been omitted and/or which chirps have been processed.

### Example 3: Reduction by Selecting Reception Channel

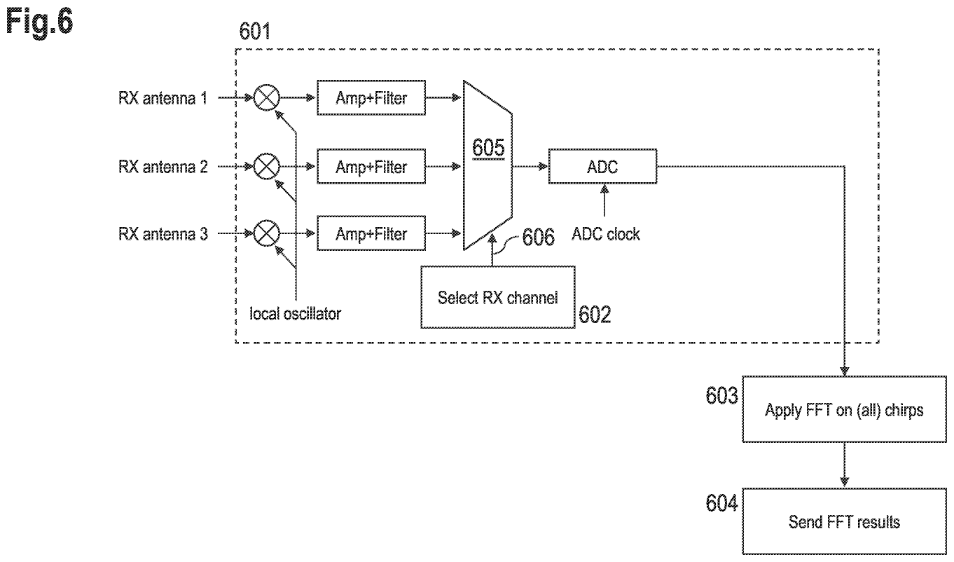

FIG. 6 shows an exemplary diagram visualizing a reduction of data occurring within an MMIC 601, which may be a schematic simplification of the MMIC 201 shown in FIG. 2 and FIG. 3.

According to an example shown in FIG. 6, the MMIC 601 comprises three receiving branches, each for one receiving antenna (RX antenna 1 to RX antenna 3). Each branch works as follows: A mixer multiplies a signal from the receiving antenna with a local oscillator signal and the result is fed to an amplifier and filter (“Amp+Filter”). The amplified and filtered result is conveyed to a multiplexer 605. In this example, the multiplexer 605 has three inputs and a single output. A signal 606 controls which input of the multiplexer 605 is connected to its output. Hence, the signal 606 selects one of the receiving channels for a predefined amount of time.

The signal 606 is provided by a select signal 602, which enables a random, pseudo-random or deterministic selection of RX channels. For example, each of the receiving channels can be selected at substantially the same rate.

The output of the multiplexer 605 is conveyed to an analog-to-digital converter (ADC), which is driven by an ADC clock.

The output of the ADC is fed to the first stage FFT unit, which determines FFT results (see step 603). Next, the FFT results are conveyed from the decentralized ECU 301 to the central ECU 302 in a step 604.

### Further Embodiments and Advantages

It is noted that preferably all chirps are emitted and the signals received at the various antennas of the radar sensor ECU 301 are further processed by reducing the overall data to be conveyed towards the central ECU 302.

The reduction may be achieved by reducing the number of chirps that are subject to further processing. In other words, not all chirps are further processed. The selection may be conducted according to a random or deterministic scheme.

In an exemplary use-case, several radar sensor ECUs are provided together with at least one central ECU in a vehicle.

In one or more examples, the functions described herein may be implemented at least partially in hardware, such as specific hardware components or a processor. More generally, the techniques may be implemented in hardware, processors, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium, e.g., a computer-readable transmission medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

Instructions may be executed by one or more processors, such as one or more central processing units (CPU), digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a single hardware unit or provided by a collection of interoperative hardware units, including one or more processors as described above, in conjunction with suitable software and/or firmware.

Although various exemplary embodiments of the invention have been disclosed, it will be apparent to those skilled in the art that various changes and modifications can be made which will achieve some of the advantages of the invention without departing from the spirit and scope of the invention. It will be obvious to those reasonably skilled in the art that other components performing the same functions may be suitably substituted. It should be mentioned that features explained with reference to a specific figure may be combined with features of other figures, even in those cases in which this has not explicitly been mentioned. Further, the methods of the invention may be achieved in either all software implementations, using the appropriate processor instructions, or in hybrid implementations that utilize a combination of hardware logic and software logic to achieve the same results. Such modifications to the inventive concept are intended to be covered by the appended claims.

What is claimed is:

1. A method for processing radar signals at a first radar unit comprising:
receiving the radar signals via at least one receiving antenna,
selecting a portion of the radar signals or of data that is based on the radar signals for further processing, and
conveying a reduced amount of data to a second radar unit, wherein the reduced amount of data is based on the portion of the radar signals or of data that is based on the radar signals.

2. The method according to claim 1, wherein the first radar unit is a radar sensor electronic control unit.

3. The method according to claim 2, wherein the second radar unit is a central electronic control unit.

4. The method according to claim 2, wherein the portion of the radar signals or of data that is based on the radar signals is selected on at least one of the following:
a random basis,
a pseudo-random basis,
a deterministic selection scheme.

5. The method according to claim 1, wherein an information regarding the portion of the radar signals or of data that is based on the radar signals is conveyed to the second radar unit.

6. The method according to claim 1, wherein the selecting of the portion of the radar signals or of data that is based on the radar signals comprises at least one of the following:
a selection of chirps;
a selection of fast-Fourier transform (FFT) results;
a selection of at least one receiving channel;
a selection of analog signals;
a selection of digital signals.

7. The method according to claim 1, wherein the portion of the radar signals or of data that is based on the radar signals comprises output data of an interference detection.

8. A device for processing radar signals, wherein the device comprises a processing unit that is arranged for
receiving the radar signals via at least one receiving antenna,
selecting a portion of the radar signals or of data that is based on the radar signals for further processing,
conveying a reduced amount of data to a second radar unit, wherein the reduced amount of data is based on the portion of the radar signals or of data that is based on the radar signals.

9. The device according to claim 8, wherein said device is a first radar unit.

10. A computer program product directly loadable into a memory of a digital processing device, comprising software code portions for performing the steps of the method according to claim 1.

11. A device for processing radar signals, comprising:
a plurality of receiving antenna ports,
a plurality of mixers each having a receive input, a local oscillator input, and an output, wherein the receive inputs of the plurality of mixers are coupled to the plurality of receiving antenna ports, respectively, and the local oscillator inputs of the plurality of mixers are coupled to a local oscillator terminal;
a plurality of amplifier and filter units each having an input and an output, the inputs of the plurality of amplifier and filter units coupled to the outputs of the plurality of mixers, respectively; and
a selection block having a plurality of inputs, a control terminal, and an output, the plurality of inputs of the selection block being coupled to the outputs of the plurality of amplifier and filter units, respectively.

12. The device for processing radar signals of claim 11, wherein the control terminal of the selection block selects a selected input from the plurality of inputs of the selection block based on a random basis.

13. The device for processing radar signals of claim 11, wherein the control terminal of the selection block selects a selected input from the plurality of inputs of the selection block based on a pseudo-random basis.

14. The device for processing radar signals of claim 11, wherein the control terminal of the selection block selects a selected input from the plurality of inputs of the selection block based on a deterministic selection scheme.

15. The device for processing radar signals of claim 11, further comprising:
an analog-to-digital (ADC) having an input and an output, the input of the ADC coupled to the output of the selection block; and
a fast-Fourier transform (FFT) unit having an input coupled to the output of the ADC.

16. The device for processing radar signals of claim 11, wherein the selection block is a multiplexor having N inputs and a single output, wherein N is three or more.

17. The device for processing radar signals of claim 11, wherein the selection block is configured to receive a plurality of chirps on the plurality of inputs of the selection block for a given time, and select only one of the chirps to provide to the output of the selection block at the given time.

18. The device for processing radar signals of claim 17, wherein the selected only one of the chirps provided to the output of the selection block consumes less bandwidth than the plurality of chirps on the plurality of inputs of the selection block.

19. The device for processing radar signals of claim 11, wherein the selection block is configured to receive a plurality of analog signals on the plurality of inputs of the selection block for a given time, and select only one of the analog signals to provide to the output of the selection block at the given time, wherein the selected only one of the analog signals provided to the output of the selection block consumes less bandwidth than the plurality of analog signals on the plurality of inputs of the selection block.

20. The device for processing radar signals of claim 11, wherein the selection block is configured to receive a plurality of digital signals on the plurality of inputs of the selection block for a given time, and select only one of the digital signals to provide to the output of the selection block at the given time, wherein the selected only one of the digital signals provided to the output of the selection block consumes less bandwidth than the plurality of digital signals on the plurality of inputs of the selection block.
